(19) United States
(12) Patent Application Publication
(10) Pub. No.: US 2013/0006850 A1
(43) Pub. Date: Jan. 3, 2013

(54) Fast Cash Transactions (FCT)

(76) Inventor: Raanan Liebermann, North Haven, CT (US)

(21) Appl. No.: 13/546,029

(22) Filed: Jul. 11, 2012

Related U.S. Application Data
(63) Continuation-in-part of application No. 09/662,451, filed on Sep. 14, 2000, now Pat. No. 7,287,009.

(51) Int. Cl. G06Q 40/00

(52) U.S. Cl. 705/39

(57) ABSTRACT

A Fast Cash Transaction System is provided enabling financial transactions among individuals and business entities including usage of Letter of Credit, whereas electronic and mobile communication devices enable transactions without the need for a credit card or bank relationship.

### CROSS REFERENCE TO RELATED APPLICATION(S)

This application is a continuation-in-part and claims the benefit of U.S. Ser. No. 09/662,451, entitled “SYSTEM AND A METHOD FOR CARRYING OUT PERSONAL AND BUSINESS TRANSACTIONS”, filed Sep. 14, 2000, now U.S. Pat. No. 7,287,009.

### BACKGROUND

1. Field of the Invention The present invention relates to movement of funds between and among persons, parties and entities, safeguarding the security of at least one of the transaction(s), the funds, and the person(s) involved in said authorized transaction(s). It further embodies processes related to movement of funds including use of mobile communication devices without being near a point of sale, as well as being at a point of sale or an automated teller machine. The instant disclosure of method and system herein is referred to as the “Fast Cash Transactions” system or “FCT”.

2. Prior Art

Financial transactions utilizing a PIN have been in operation for some time. Specific systems and methods for personal and business transactions where intermediary accounts are being set for specific transactions have been disclosed by Liebermann in U.S. Ser. No. 7,287,009 B1. The instant application claims the benefit of said patent by Liebermann and discloses additional material related to such transactions. Specifically, the instant application claims the benefit of all the FCT registration process, and operation, assigning of a ten-digit account number that is a telephone number, a PIN structure with default alarm, performing transactions, and other related elements related to the fast cash transaction system.

### SUMMARY OF THE INVENTION

The technology and process are that of moving funds from one account to another, enabling at least one of a depositing an amount, withdrawing an amount, payment for and/returns of merchandise with at least one of a refund and crediting user(s) thereof, service, placing an amount in escrow, refund(s), and letter of credit operation(s). The technology and system is entirely cash based, irrespective of the source of cash, being material, or credit, and assuming complete legal source and activity. Said assumption may further be verified by process of system.

The instant disclosure relates to method and system for creating a financial transaction that is built as a layer between the National Clearing House (NACHA) and the banks with layers of different security measures embedded in layers within transactional steps. Further, said method and system utilizes where appropriate mobile communication devices and their standard features in the specific processing of transactions.

The system is based on the creation of at least one ad hoc virtual account(s) before retiring said account(s) to actual monetary existing account(s). Said virtual account(s) may entail all transaction details and history and may advise the collective depository fund management of the endpoint results for settling among the protagonist parties and/or their accounts. Namely, we technically create at least one successive intermediary account(s) that is temporary and disposable, except its transactional history that may further be secured by such means as at least one of a at least one coded signifier(s) and encryption relegated to a database and removed from the actual depository funds and their management.

Transactions can be made in variety of ways. The transaction maker can perform said transaction(s) utilizing variety of auxiliary devices, such as a computing device, whether stationary, moveable or mobile, a communication device, such as a landline telephone or a mobile communication device, equipment at a point of sale (POS), an Automatic Teller Machine, cash dispenser, or TV.

### BRIEF DESCRIPTION OF THE DRAWINGS

FIG. 1 illustrates transaction between individuals with FCT account.

FIG. 2 illustrates a transaction done on line (computer or mobile)

FIG. 3 illustrates transaction at a point of sale

FIG. 4 illustrates depositing funds in FCT account or withdrawing money from it

FIG. 5 illustrates automatic deposits to and automatic deductions or payments from FCT accounts

FIG. 6 illustrates FCT usage in letter of credit or escrow operation

FIG. 7, illustrates the Personal Payment Butler activity

### DETAILED DESCRIPTION OF THE PREFERRED EMBODIMENT(S)

Any person may set up an FCT account by registering with the FCT system and even when an account is set up for an entity, it is a person who sets it up and has his or her own identity utilized in the process. It does not matter what electronic device is utilized in such registration and what electronic device is utilized in accessing the FCT system for transactions, be it for example, a landline phone, a computer, a laptop computer or a mobile communication device. Likewise, once registered, the account is accessible for transactions from any electronic device, such as the said foregoing examples.

There is no need to fund the FCT account at registration and there is no need to keep any funds in the account. The only time it matters what level of cash is in the account is when a transaction is performed. Thus, there is never a situation of a mandatory minimum balance and the account owner needs not worry about it unless a transaction is forthcoming. The system may also activate its “Personal Payment Butler” that is basically a predictive Personal Payment Butler”, a bookkeeping monitoring for each account that may alert an account holder of current and/or future payment(s) or receipt(s) of monetary events, as related to the amount available or balance in the account.

Thus, in one embodiment, the user creates an FCT account then proceeds to fund it. Funding the account, whether an initial funding after account creation or refunding it later at will may be accomplished in variety of ways. One can have funds transferred to the account by another person having an FCT account with funds by utilizing the FCT fund transfer procedure between individuals, whereby upon instruction for such transfer, the account of the transferring party is updated to reflect a new balance that has the amount deducted from it, while the account of the party receiving the funding would show a balance with said added amount, less any fees that may be associated with such transaction.

Funding an account may also occur when any FCT account holder provides an acceptable monetary instrument, such as cash, check, a credit card, a promissory note, or an item of value to another party or entity with funds in their FCT account, such as a point-of-sale of a merchant, any arbitrary person or entity, a bank, or an automatic teller machine. The party, entity or device receiving the proper value can then transfer the appropriate amount to the funded account.

Likewise, withdrawing cash from any FCT account may be performed by any account holder having suitable amount for such withdrawal in said account, performed under the set procedures of FCT. A person can forward the amount to another person who would provide that amount is cash, a person can go to a point of sale and obtain the cash at the cash register, or withdraw the desired amount at an ATM, as will be disclosed next.

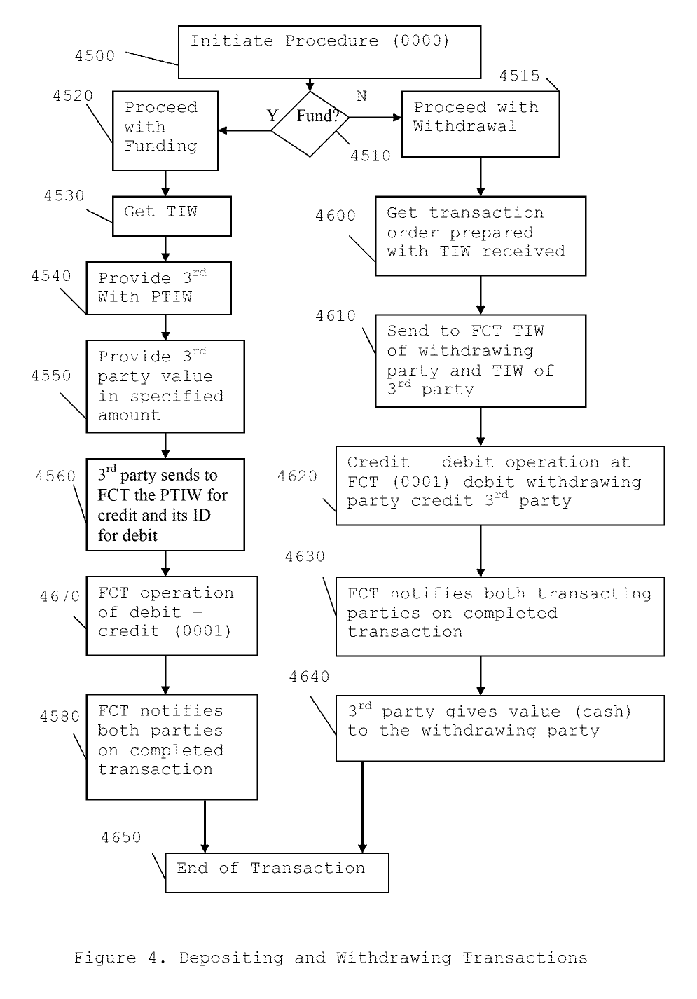

Withdrawing cash from an FCT account at a cash register or a point of sale of any merchant is equivalent to receiving a refund for returned merchandise by a customer. The “returned” merchandise is virtual in such instance as the customer provides the merchant with a virtual voucher of depositing the desired sum in the merchant's account with a possible added fee to the customer that such a transaction may carry. Specific steps that such a procedure may take are illustrated in FIG. 4.

There are a number of ways to pay from an FCT account at a point of sale for merchandise bought. A buyer can key in to a mobile device the store ID number and cashier register number with the amount due and transmit it to the FCT center, or the procedure may be automated utilizing any state of the art facility and format available. In one embodiment, usage is made of barcode and/or other codes, such as pixel arrangement technology that may form various geometric forms differentiating between and among colored and non-colored surfaces, such as in the Quick Response Codes (QR Codes) that will be disclosed next.

The Cash register utilized by a merchant, such as in a store may provide a buyer with the sum total of the purchase cost that may appear on at least one of a electronic screen and paper document, such as a receipt printed by the cash register or a screen connected to said register. In addition to the cost of purchase said information may also include at least one of a at least one barcode(s) and at least one other pixel arrangement(s). Namely, said barcode(s) or other pixel arrangement(s) may include at least one of a store ID, cash register ID, cashier ID, and amount due by the purchasing customer. The purchasing customer may make use of a mobile communication device to affect appropriate payment by utilizing the camera on the mobile communication device to take a picture of the at least one of a at least one barcode(s) and pixel arrangement(s) with the information needed to effect payment. The paying customer may utilize the mobile unit camera as a step in the payment process, where the payment program that is part of what may have been earlier downloaded to the mobile unit at registration may signal when to take the picture of said at least one of a at least one barcode(s) and at least one pixel arrangement(s), as part of the payment process and may alert the user if any deficiency occurs in the photo process. The program on said mobile unit deciphers said barcode(s) and/or pixel arrangement(s) where appropriate and requests said buyer confirmation and the relevant PIN before transmitting all the information to the FCT center. The FCT center debits said buyer account and credits the account to the merchant. Thereupon, the FCT may send transaction confirmation to at least one of a said merchant and said buyer in whatever format that may be available in the state of the art, such as at lest one of a at least one barcode(s) and at least one pixel arrangement(s) that may be clicked by at least one of the protagonists to the transaction. The preferred embodiment may prefer the barcode approach as it seem to add more secure aspects to the operation. The word “click” is used in the instant disclosure to describe at least one of a click on a key of an electronic device and touching a specific location on a touch screen of an electronic device.

Alternatively, the cashier may take an image of at least one of either a barcode or other pixel arrangement appearing on the screen of the mobile communication unit of the purchasing customer, such as by clicking on the image with an appropriate device and forward that with the appropriate sum total purchase of the transaction to its own connectivity to the FCT. Thereupon, said buyer may receive on the mobile communication device a note from FCT requesting affirmation of the purchase that also invokes the security PIN of said customer. The at least one of a at least one barcode(s) and at least one pixel arrangement(s) identifying the customer and the relevant account associated with it would had previously been downloaded to the mobile unit of the purchasing customer, either at registration or at a later time in the case where at least one of a barcode(s) and pixel arrangement(s) are changed from time to time due to security procedures.

Yet in another embodiment, the purchasing customer indicates an upcoming purchase on the mobile communication device, such as by clicking on or touching a suitable icon and said mobile unit may request an authentication of customer by requiring a PIN. Upon entering of a correct PIN by the purchasing customer, said unit may then either request the amount to be keyed in or allow for taking an image of the price, such as by utilizing the camera on said unit. Said unit may then further present on the mobile unit screen an image of either at least one of a at least one barcode(s) and at least one pixel arrangement(s). The merchant or its designated cashier may then click on the presented image, which is sent to the FCT center for processing and suitable confirmation of transaction properly completed that may also show the amount credited to said merchant. Said barcode(s) and pixel arrangement(s) on said mobile screen is further disclosed next.

Yet in another embodiment the purchasing customer or the merchant or the designated cashier may swipe a generic plastic card or a similar card made of any material known in the art that allows connectivity to the FCT Center and wherein the purchasing customer enters his or her account number and the unique PIN to authenticate the transaction. Said card may be swiped by either the merchant, the cashier, or the customer, and the transaction would follow. The account number may be the account holder telephone number, either real or pseudo number assigned by the FCT.

The FCT system always knows who makes a transaction and at what time. When appropriate, such as by a court order, the system can track the history movement of any amount from deposit to withdrawal, irrespective of the number of transactions made. Transactions are always made by persons even if they are on behalf of an entity and any person doing a transaction leaves a personal “fingerprint” when accessing the system, wherein personal login is required with personal PIN.

An FCT account holder may enter manually information related to his or her account number, such as the account number and a PIN. However, this is not the only way to provide such information. Image(s) on the screen of a mobile communication device belonging to an ECT account holder may provide information related to the account holder, such as providing an identification for the FCT center of the specific account that may be debited for a transaction, may indicate the amount to be debited to the account of the account holder and may provide an appropriate Transaction-In-Wait (TIW) identification. Namely, upon providing a proper PIN, the mobile device may retrieves a Preliminary TIW (PTIW) from the PTIW databank in the mobile unit that is discussed next, and annexed said PTIW to the barcode(s) or pixel configuration(s) ID of the customer (without the PIN that is only used to very the user and produce the PTIW). Such information that may be summed up in at least one barcode(s) and/or pixel arrangement(s) may be provided to a third party, such as a cahier at the cash register of a Point-of-Sales. The third party, such as said casher obtains all necessary information to debit the account holder for the purchases that were presented by the customer by clicking on the image with a suitable device that reads the image information from the screen of the mobile communication device. Said cashier forwards to the FCT center the information through the electronic system at the disposal of said cashier that may include also the identification of the specific merchant and the total amount to be charged to customer. The FCT center verifies the PTIW as belonging to the correct customer, turning the PTIW to a TIW and sends customer a confirmation request for the total amount, that may include the FCT's own PIN that is described below. Verification by customer sent to the FCT with the correct PIN of the customer enables the FCT to remove the TIW status, debit the customer and credit the merchant. An FCT final confirmation may be sent to both the purchasing customer and the merchant, where each confirmation carries the unique PIN of the FCT related to each member of the transaction.

A group of at least one PTIW may be provided any new customer registering with the FCT System or center and is replenished, changed or undergoes various processing from time to time. Said PTIW resides in the database of the user with a copy thereof at the FCT System or Center.

There may be two different PIN codes associated with each FCT account holder. One PIN is the personal PIN identifying and verifying the account holder for the FCT System or Center and a totally separate PIN identifying and verifying the FCT System or Center for the account holder. The PIN of the FCT is useful when an account holder desires verification that an amount of money paid by the account of the account holder or amount received at the account of the account holder did indeed occur and handled by the FCT. As an example, one can imagine an unauthorized use of an FCT account where a person or entity masquerades as the FCT Center, acknowledging receipt and credit of an amount, say in a real estate transaction that is false and leaves the FCT account holder without title and without the amount that was supposedly paid for in the transaction. An FCT PIN verifies electronic receipt of appropriate payment would be useful in such and other cases.

Thus, the FCT System or Center has its own PIN code that is specific for each customer, wherein said PIN code is used for confirmation and verification of money received and credited to a customer account or alternatively debited to said account. Said PIN code may be transmitted to an account holder when confirming a transaction and may be at least one of a at least one alphanumeric character, at least one barcode(s), or at least one pixel arrangement(s). The electronic unit at the disposal of the account holder, such as a computer or mobile communication device may then translate the form of the received PIN into an appropriate assertion for the account holder, unless said PIN code is at least one alphanumeric character(s). The recipient of the FCT PIN code, would recognize said unique FCT PIN issued for the customer and be secured in the transaction.

FCT can be utilized for a Letter of Credit in variety of forms. It can serve as the monetary vehicle in the traditional letter of credit processed by banks, as well as taking a facilitator role in addition, that may take a role from a minimal activity to complete replacement of a banks involved in traditional letter of credit operations. In the preferred embodiment, the FCT semi-automates the process and due to its structure enables to become a substitute for both the beneficiary bank and the advising bank. The Letter of Credit operation of the FCT may also utilize the Personal Payment Butler for alerts to actions needed in the process. Description of the Personal Payment Butler is disclosed hereinbelow. It enables the applicant and beneficiary to handle the paperwork themselves based on a structured format of contract agreements that are pre-prepared and reside in the FCT databank, wherein certain areas may be marked for usage in any particular case. The FCT also provides an online tutorial for the process and for the forms and at the completion of preparation enables a presentation to each party of the summary of the contract elements and schedule dates. The payment for the goods is deposited in an FCT escrow account carrying a unique TIW for each case and the account of the beneficiary is credited when all paperwork has been completed and all clauses satisfied. The process also directs the buyer to buy at his or her discretion proper insurance while such selection is the prerogative of the buyer.

Since the FCT has the option for the customer to set the account for automatic withdrawals, such as paying rent on time as well as automatic deposits, such as Social

Security or veteran disability automatic monthly deposit balancing the FCT cash account may benefit from the options built into the system. The system provides an instantaneous balance of all deposits, withdrawals and payments, together with relevant source information, target information, amount and dates. However, the FCT is user friendly beyond such amenities and may also serve if so desired by a user as a “Personal Payment Butler” (or “PPB”) alerting the user to any upcoming financial act affecting the user and its ramifications. Namely, in one such example, said Personal Payment Butler may alert the user that an automatic payment coming out of the cash amount in the user's account may put the user in a negative balance and as such would not be paid by the FCT rules, prompting the user to deposit an appropriate amount in the account ahead of the specified date. Further, even if the user does not specify such payments in automatic mode, the FCT system contains and artificial intelligent mode that “learns” from same type payments on regular basis, reaches conclusions and alerts the account owner that if another pay-like situation occurs at a date-like period, the account may be low on funds and require appropriate deposits. Further, even if funds are insufficient, the personal payment butler may just the account holder to pay a bill that it believes might be due on a particular date, unless such payment is turned off by the user. Extending the PPB service beyond financial transaction is possible and the instant disclosure covers such embodiments as well. One such example is when the PPB detects activity that is unusual compared to existing pattern, or that an amount anticipated, such as a social security payment did not come in at the anticipated time.

Credit verification utility. It is a known commercial fact that people are judged as related to their reliability in social economic situations by checking their credit or banking relationship. Such may be the case when a person may be considered for hiring for a new job to work in a new company, when applying for renting an apartment, or buying a new car with a down payment and successive installment payments. More often than not, credit history is checked in order to determine, what the checking party may consider as reliability and suitable functioning within the norms of society standards. In order to allow for an FCT account holder who does not have credit or banking relationship the same non-prejudicial amenity as those who do, the FCT provides a similar service that is available to FCT account holders under their authorization. Said service may be technically obtained in part by the system utilizing such data as may be available in the database related to the predictive Personal Payment Butler (PPB), as well as other material.

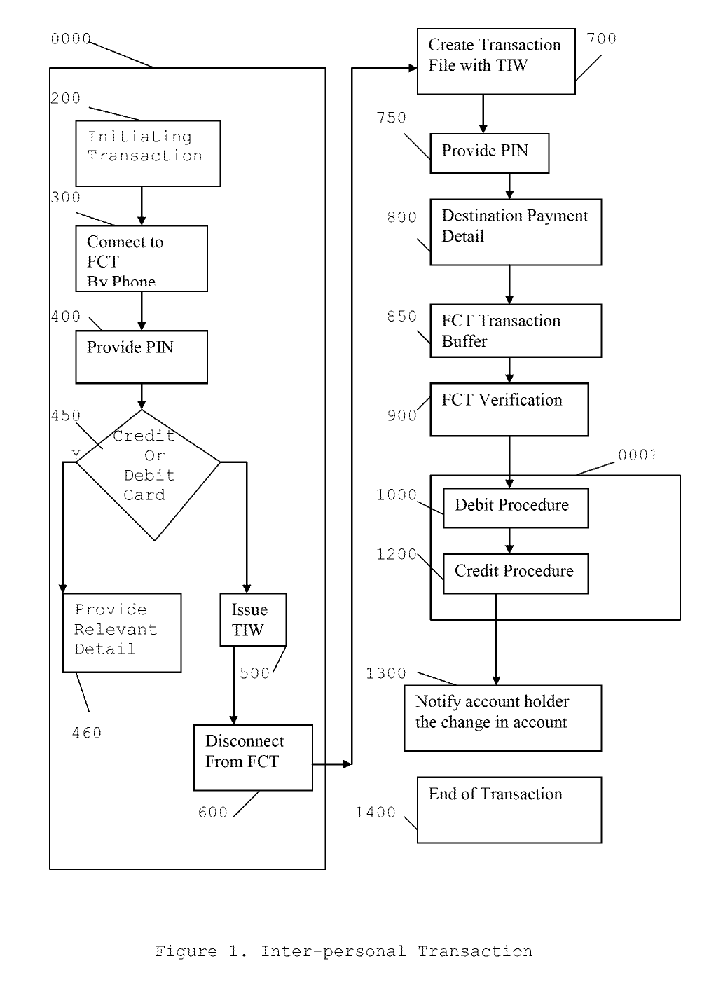

Turning now to FIG. 1 illustrating transaction between individuals with FCT accounts, an account holder initiates in (200) such a transaction by clicking a key or touching a specific location on a touch screen of an electronic device. Thereupon the electronic device having communication capabilities connects to the FCT Center, preferably by phone communication in (300) and account holder provides his or her specific PIN in (400). The system then inquires in (450) if said account holder wishes to utilize a credit or debit card. If the answer is affirmative then said account holder provides relevant information in (460) and receives a TIW issued by the FCT system in (500). Otherwise, if the query in (450) produces a negative answer, the system proceeds directly to provide the TIW to said account holder in (500). Once the TIW has been provided in (500), the communication between the electronic device having communication capability and the FCT Center may be terminated for the purpose of security and the connection is disconnected in (600). The entire cycle of procuring a TIW independent of the specifics of any transaction as shown in (200) through (600) is the Procedure Initiation in (0000). Upon disconnection from the FCT Center in (600) a transmission file is created in the electronic device in (700) enabling proceeding with the transaction initiated by the account holder operating the electronic device wherein the transmission file is based on the TIW received from the FCT Center. The transaction initiator provides the system with the personal PIN in (750), unless such securing step was already done and then provides in (800) details, such as the amount and target account for crediting with the amount. Subsequently, the transaction file with all said information is kept in an FCT transmission buffer in (850), while the FCT system verifies in (900) such details as the destination account, the TIW and its relationship to the transaction initiator and whether sufficient funds are available for payment in the account of the transaction initiator. The FCT system then proceeds with a debiting and crediting operation in (0001) wherein the account of the transaction initiator is debited in (1000) by the amount provided in (800) and the account of the recipient is credited by said amount in (1200). Thereupon each account holder is notified in (1300) about the changes in the relevant account, wherein the account of the transaction initiator reflects a suitable smaller amount remaining after deducting the payment amount specified in (800) as well as any transaction fees that may be appropriate. The notification in (1300) includes the unique FCT own PIN for the specific party ascertaining the veracity of an FCT transaction. The transaction ends in (1400).

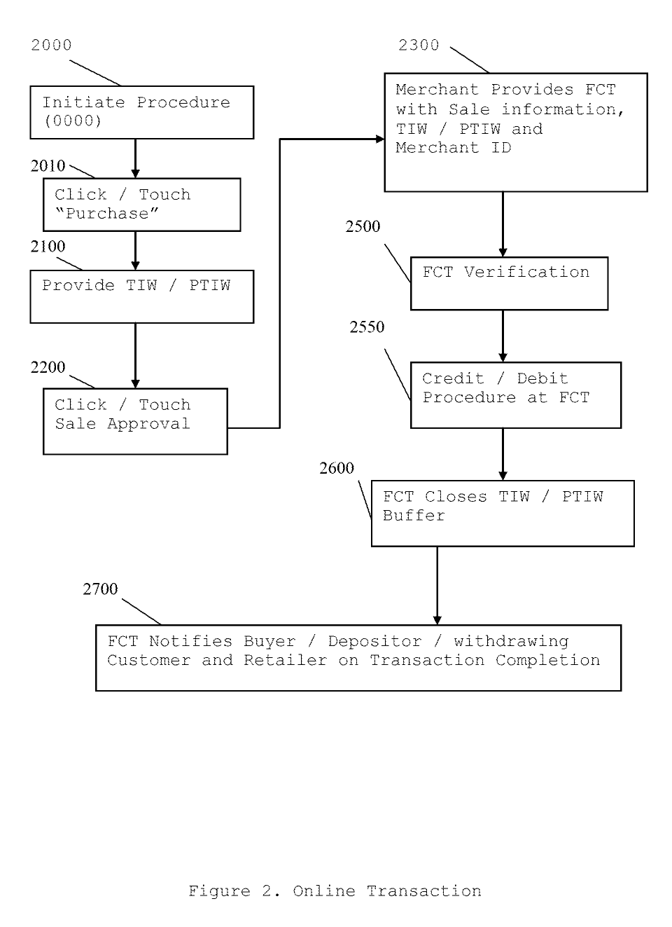

FIG. 2 illustrates a transaction done on line whether by utilizing a computing device such as a server, desktop or laptop, or a mobile communication device. The (0000) procedure is initiated in (2000) and the buyer clicks a key or touches the touch screen area indicating “Purchase” in (2010), which provides the seller with the TIW or PTIW of the buyer. The buyer reviews the sale information and indicates approval in (2200). The merchant transmits in (2300) all pertinent sale information to the FCT Center that may include the amount of the sale, the TIW or PTIW of the buyer and ID of the merchant that may include the merchant's own PTIW or PIN. Thereafter the transaction undergoes the standard FCT verification in (2500) and the debit—credit transaction at the FCT (0001) occurs in (2550). The ECT then closes in (2600) the buffer with all the information used for the transaction and notifies buyer and seller in (2700) about the completed transaction that may include the amount deducted from the buyer and added to the seller, less any fees that may have been appropriate. Each party receiving the FCT confirming notification receives it with the FCT unique PIN that is the FCT verification of its own entity for the specific account holder.

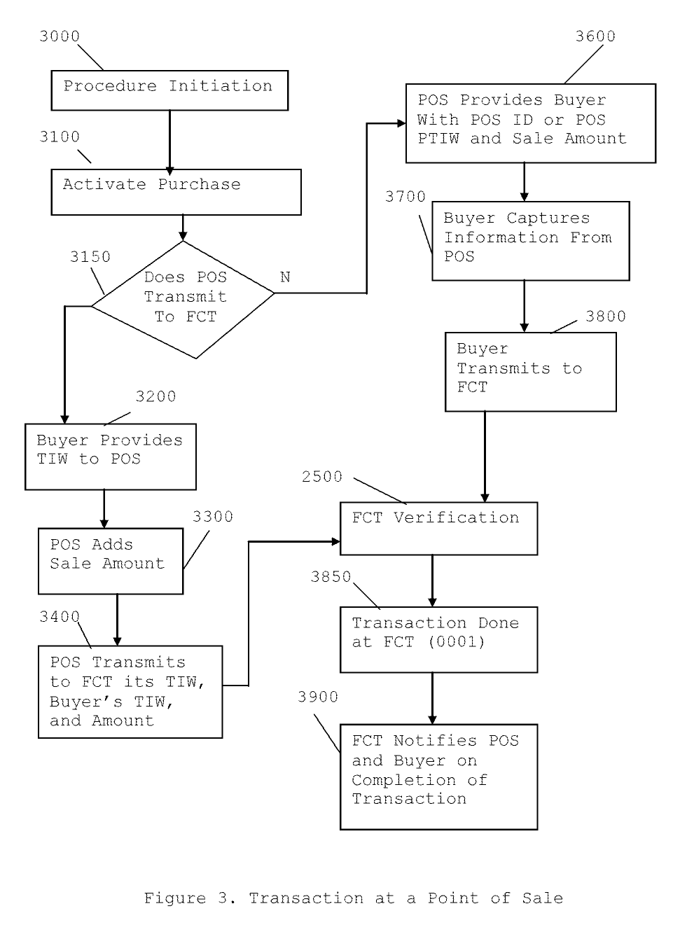

FIG. 3 illustrates transaction done at a point of sales, whether by utilizing a computing device, such as a server, desktop computer or laptop computer, or alternatively a communication device such as a telephone or mobile communication unit. Procedure initiation takes place in (3000) that appears in detail in (0000). The FCT account holder click a key or touches the appropriate location on screen of the electronic device to indicate purchasing in (3010) and then provides in (3100) the TIW instead of an account number and may also enter a PIN. The answer to the query in (3150) determines who transmits the transaction to the FCT Center. If the answer to whether the Point of Sale (POS) does the transmission is affirmative then the purchasing customer provides the POS in (3200) with the TIW obtained in (0000). The POS then proceeds to add to it the purchasing amount in (3300) that my also contain its own ID for the FCT. The POS then transmits in (3400) to the FCT Center its ID, the purchasing customer TIW and the total amount of purchase. Upon receipt, the FCT conducts its verification in (2500) and proceeds to the appropriate credit—debit procedure in (0001). If the answer to the query in (3150) was negative, then the POS provides in (3600) the purchasing customer with the amount of the purchase as well as with one of its pre-procured PTIW. The purchasing customer captures in (3700) said information provided in (3600), by such forms as by hearing, sight, or by taking an image of it with a mobile communication device, wherein the information may be contained in such forms as voicing it to the purchasing customer, at least alphanumeric characters, a barcode or pixel xxxxxxxxxxxxxxx or combination of them. The buyer then transmits in (3800) the information received in (3700) to the FCT Center with its own ID supported with his or her own PIN. The FCT Center performs its verifications in (3500) and proceeds with the debit—credit transaction. At the end of the transaction, the FCT Center notifies in (3900) both parties regarding the transaction with its own unique PIN for each party as described above.

FIG. 4 illustrates depositing and withdrawal procedures in an FCT account. Initiation procedure (0000) takes place in (4500) and the party is queried in (4510) if it the party wants to fund an FCT account. If the answer is affirmative the process proceeds with funding in (4520) and the funding party either uses a previously obtained PTIW in (4530) or acquires a new TIW from the initiation procedure in (4500). The funding party then provides in (4540) the third party with the TIW or PTIW and proceeds also to provide in (4550) the third party with the intended value, such as cash. The third party then sends in (4560) the FCT Center the needed TIW/PTIW, as well as its own ID, with an order to credit the funding party with said sum and debit its own (third part's) account by said sum. The FCT center calculates the appropriate fees and debits the needed parties by it according to the set rules of the system. Thereupon, the FCT operation of debit—credit (0001) takes place in (4570) and the FCT Center notifies in (4580) both parties of the completed transaction, providing also the FCT's specific PIN as related to each party for verification of the transaction. The transaction then ends in (4650) with the funding party having the said value in its account while the third party has that value deducted from its account but has now that amount available in value such as cash on hand. If the answer to the query in (4510) is negative, then the transaction proceeds with withdrawal in (4515). The transaction order is then prepared in (4600) and sent to the FCT Center in (4610), wherein it contains the TIW or PTIW of the withdrawing party, the amount to be withdrawn and the ID of the third party as well. Next the FCT Center handles the (0001) debit—credit operation in (4620) and subsequently the FCT Center notifies in (4630) both transacting parties that the transaction completed successfully and thereupon the third party provides in (4640) value, such as cash to the withdrawing party. Finally, the transaction ends in (4650).

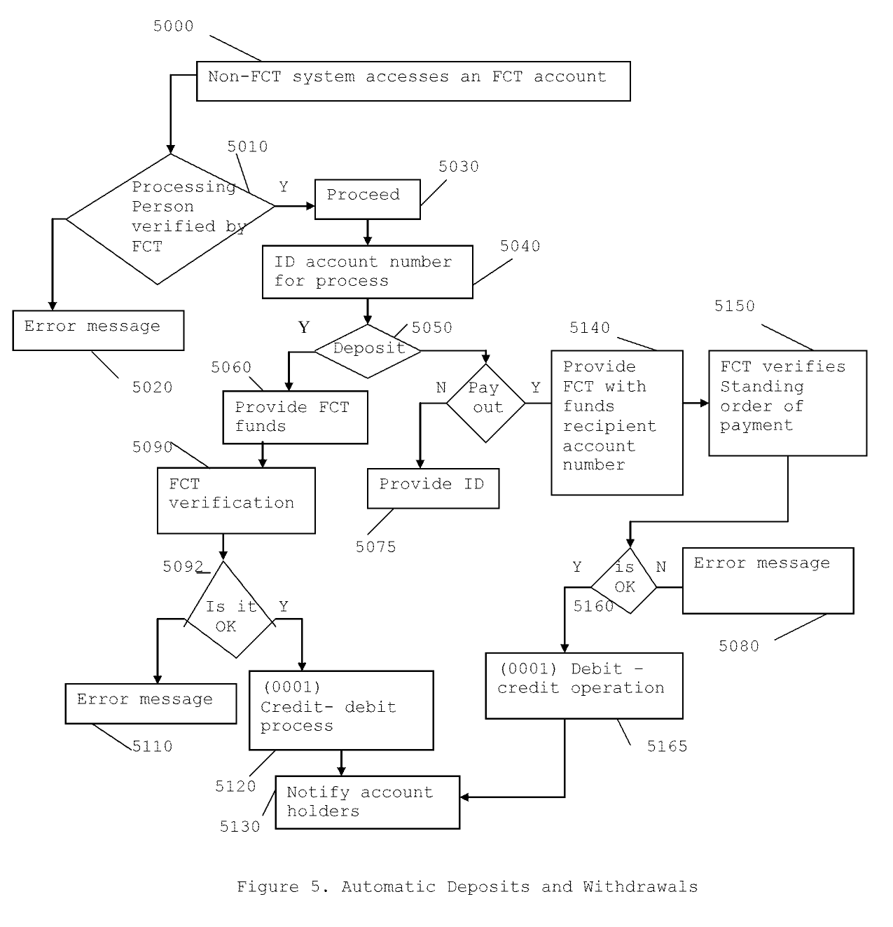

FIG. 5 illustrates automatic deposits to and automatic deductions or payments from FCT accounts. A non-FCT account accesses the FCT Center in (5000). Next it is queried in (5010) if the person processing the non-FCT account is an FCT account holder. if the answer turns negative an error message is generated in (5020) with no further access to the system. However, if the answer is affirmative in (5010) then the transaction proceeds in (5030). Identification of the account for process is provided in (5040) and it is queried in (5050) whether it is a deposit transaction. If the answer is affirmative then the FCT Center receives in (5060) on behalf of the account identified in (5040) the verifiable monetary input. Thereupon, the FCT Center verifies in (5090) that indeed there is a standing order for deposit into said account and possibly also the amount or order of magnitude of said amount. If the verification is unsuccessful as indicated by a negative answer to the query in (5100), the system generates an error message in (5110). However, if the verification in (5100) is successful then the system proceeds in (5120) with its (0001) operation of crediting said account and debiting the depositing entity and then proceeds in (5130) to notify the account holder on the successful deposit and upgraded balance in the account.

If the query about depositing in (5050) returns negative, the system proceeds to debit said account as follows. First it is queried in (5070) if a payment is contemplated out of the account to the credit of the non-FACT entity in (5000) or to an account of another entity. If the answer to the query in (5070) is negative then an ID is provided the FCT in (5075) and the process progresses to providing in (5140) the FCT with funds from the account in (5040). If the answer to the query in (5070) is affirmative so that the non-FCT account in (5000) is the one to whom payment is due, then the system debits the account in (5040) by the appropriate amount providing the FCT system in (5140) the funds for the transaction. Subsequently, the FCT verifies in (5150) the standing payment order, amount and destination account, all to be in line of the information provided. It is queried in (5160) whether the verification was positive and if the answer is negative then an error message is generated in (5080). However, if the query in (5160) is affirmative then the system proceeds in (5165) to perform its (0001) process of debiting the account in (5040) and crediting the entity in (5000). Finally the FCT system notifies in (5170) both parties on the successful completion of the transaction with its own unique FCT authentication for each party.

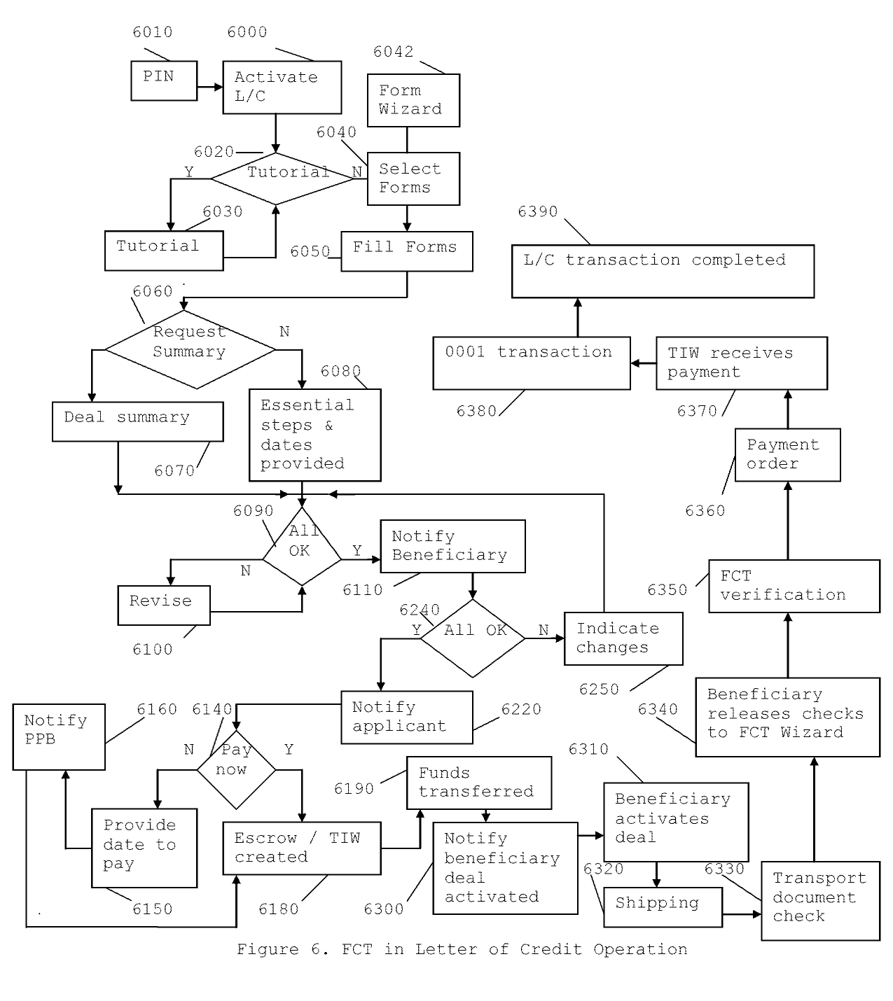

FIG. 6 illustrates the FCT usage in letter of credit or escrow operation. The applicant who is the intended buyer enters a personal FCT PIN in (6010) and activates the Letter of Credit operation in (6000). The buyer is then offered a tutorial in (6020) that covers among other things the process, type of forms, how to fill up the forms, schedules and payments. It also covers taking out insurance on the goods shipped, once they are out of the control and responsibility of the beneficiary, while the funds are out of control and possession of the buyer. If the buyer selects the tutorial then it is provided in (6030) and otherwise the buyer may start selecting the needed forms to fill in (6040) and may take advantage of the Form Wizard in (6042). The forms are filled in (6050 and the applicant is queried in (6060) if a summary is required, so that the various details may not obscure goal. If the answer to the query in (6060) is negative then the essential steps and dates are provided in (6080). However, if the answer to the query in (6060) is affirmative, then a summary is provided in (6070). Either way, the applicant subsequently queried in (6090) if all seems appropriate. If the answer to the latter query is negative then revisions are taken place in (6100) and the applicant is queried again in (6090) if it is now acceptable or additional revisions are desired. When the answer to the query in (6090) is affirmative the beneficiary is notified in (6110) and is queried in (6240) if all is acceptable. If the beneficiary desires changes then they are indicated in (6250) and are subject to acceptance in the query of (6090). If they are not accepted then revision takes place in (6100) with as many iterations as needed, and the beneficiary is notified again in (6110 until the answer to the query in 6240) is affirmative and then the applicant is notified in (6220). On such notification, the applicant now has to secure the payment in order to the deal to be activated. Thus the applicant is queried in (6140) whether to pay now and if the answer is negative then the buyer provides in (6150) the payment date and the Personal Payment Butler (PPB) is notified in (6160) in order to ascertain payment on time that will result in opening in (6180) an escrow account with a TIW for the transaction. If the answer to the query in (6140) is affirmative then said escrow account with the TIW is opened in (6180). Once the escrow account with the TIW is funded in (6190), the beneficiary is notified in (6300) and the beneficiary then activates the deal in (6310). Once the deal is activated in (6310) shipping of the goods takes place in (6320) and transport document check occurs in (6330). The documents checks result is releasing them to the FCT wizard in (6340) and the FCT verification is done in (6350). Following the FCT verification in (6350) a payment order in (6360) is generated at the FCT the TIW for the case receives the payment in (6370) utilizing the funds that were transferred in (6190). The final financial transaction in the letter of credit takes place in the (0001) debit—credit operation in (6380) and the letter of credit transaction is then complete in (6390).

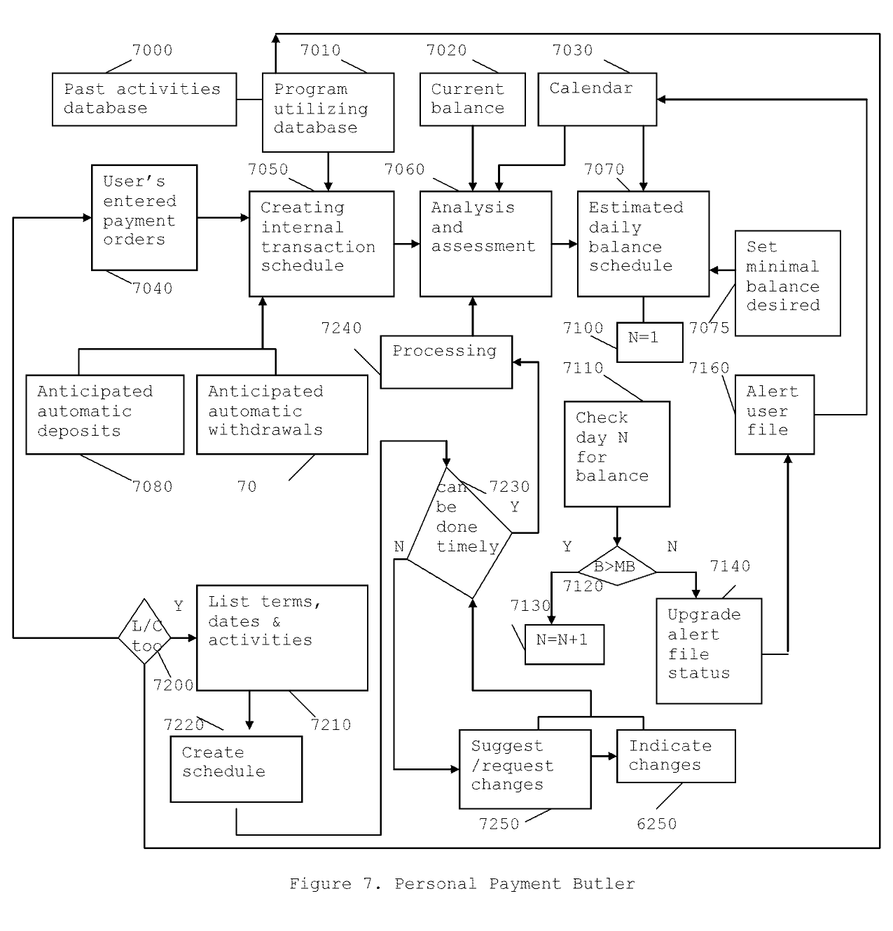

FIG. 7 illustrates the Personal Payment Butler (PPB) activity. Past payments and receipts activities are housed in the database in (7000) that is connected in (7010) to a program utilizing said database. The program in (7010) creates in (7050) an internal transaction schedule that leads to an assessment in (7060) that is done in conjunction with the current balance in (7020) and information received from the anticipated automatic deposits in (7080) and the anticipated automatic deductions in (7090). The internal transaction order in (7050) also receives information from a user's entered payment orders in (7040). The assessment progresses to an estimated daily balance schedule in (7070) that is done in conjunction with the calendar in (7030). Also a minimal balanced desired is established by the account holder in (7075). Said minimal balance (MB) can be changed from time to time as desired by the account holder. The counter is set to one in (7100) so that daily balance checks in (7110) can be performed successively wherein the Balance (designated in the drawing as “B”) is compared with the Minimal Balance (designated in the drawing as “MB”) can report inadequacy. Thus, the PPB is queried in (7120) whether the balance (B) is larger than minimal balance (MB) established in (7075). If the answer is affirmative, the counter is upgraded in (7130) for the next comparison event in (7110). However, if the answer to the query in (7120) is negative, meaning that the balance is not above the minimal balance established then the alert file status is upgraded in (7140) and the user file in (7160) is alerted so that it may alert the user in whatever manner the user prefer. The latter alert file in (7160) is also linked to the calendar in (7030), in order to enable date coordination and assessment by the account holder. The personal Payment Butler is also useful in handling letters of credit (designated as “L/C” in the drawing) due to the important correlations of date for certain activities according to the contract established between the applicant and the beneficiary. The program in (7010) utilizing the database in (7000) also activates the query in (7200) to whether a letter of credit is to be considered. If the answer is negative, then the system simply continues with the users entered payment orders in (7040). However, if the answer to the query in (7200) is affirmative, the system reviews in (7210) the terms, dates and activities related to the letter of credit and creates in (7220) an appropriate schedule for fulfillment utilizing also the calendar in (7030). The system then queries in (7230) if all can be done in time. If the answer to the query in (7230) is negative it suggests in (7250) that changes may be requested (from the beneficiary) in order to ascertain proper fulfillment of the transaction, which duly transmitted to the letter of credit operation in (6250), indicating the changes and proceeding from there, then checks back in (7230) to see if changes that were presumably made in (7210) based on its recommendation are now doable. If the answer to the query in (7230) is affirmative the system goes into processing in (7240) that feeds into the analysis and assessment in (7060). Thus we see that importance of the Personal Payment Butler, both in conducting business, such as utilizing a letter of credit, as well in personal monitoring and ascertaining one meets his or her monetary obligations in our society.

It is apparent that there has been provided in accordance with the present invention a personal and business transaction system and method which fully satisfies the means, objects and advantages set forth hereinbefore. While the present invention has been described in the context of specific embodiments thereof, other variations, alternatives, and modifications will become apparent to one skilled in the art after reading the foregoing description. Therefore, it is intended to embrace all variations, alternatives, and modifications that fall within the broad scope of the appended claims.

Other details of the translation system of the present invention, as well as other objects and advantages attended thereto are set forth in the following detailed description and the accompanying drawings, where like reference numerals depict like elements.

What is claimed is:

1. A method for performing at least one of a personal and business monetary transaction utilizing at least one electronic device(s) wherein said transaction processing comprises currency and does not require a credit instrument or a bank relationship.

2. The method in accordance with claim 1, wherein said credit instrument comprises at least one of a credit card, credit account identification, a credit card number, and a line of credit.

3. A method in accordance with claim 1 wherein said transaction utilizes an account registered to an account holder and wherein said account holder utilizes an electronic device for at least one of a perform or cause to be performed at least one of a payment from said account, withdrawal from said account, and depositing funds into said account.

4. The method in accordance with claim 3 wherein said payment is made in at least one of a time of actual transaction occurrence, and a prescheduled future time.

5. The method in accordance with claim 1 wherein said transaction is made between one party and at least one of a another party, a point of sale in a merchant facility, automated teller machine, business entity, governmental entity, non government organization, a not for profit organization, online, and a bank and wherein said party is at least one of a at least one individual(s) and at least one entity(s).

6. The method in accordance with claim 1 wherein said electronic payment utilizing said electronic device(s) includes at least one of a cash, at least one disposable electronic check(s), at least one disposable electronic money order(s), and at least one Transaction-in-Wait temporary holding account(s) bearing currency.

7. The method in accordance with claim 5 wherein processing payment to a recipient at a point of sale includes at least one of a central processing center, a recognized card swiped that is recognized by said processing center, at least one alphanumeric character(s) identifying an account holder to said processing center, at least one barcode(s), at least one pixel arrangement(s), at least one device(s) for reading said at least one of a said barcode and said pixel arrangement, and at least one camera attached to an electronic device wherein at least one of a said at least one alphanumeric character(s), at least one said barcode(s) and at least one said pixel arrangement(s) identify at least one of a merchant facility, specific cash register, a specific cashier, amount of transaction, the central processing center, and account holder identification for a specific amount to be paid in said transaction to at least one of a said recipient and said account holder.

8. The method in accordance with claim 1 wherein the central processing center issues to at least one of a at least one account holder(s), at least one entity(s), and at least one another party(s) in said transaction at least one of a unique personal account identification, unique personal password identification, and a unique personal identification of said processing center identifying uniquely said processing center to each recipient of said at least one of a unique account identification, and unique password identification.

9. A system for performing at least one of a personal and business monetary transaction utilizing at least one electronic device(s) wherein said transaction processing comprises currency and does not require a credit instrument or a bank relationship.

10. The system in accordance with claim 9, wherein said credit instrument comprises at least one of a credit card, credit account identification, a credit card number, and a line of credit.

11. The system in accordance with claim 9 wherein said transaction utilizes an account registered to an account holder and wherein said account holder utilizes an electronic device for at least one of a perform or cause to be performed at least one of a payment from said account, withdrawal from said account, and depositing funds into said account.

12. The system in accordance with claim 11 wherein said payment is made in at least one of a time of actual transaction occurrence, and a prescheduled future time.

13. The system in accordance with claim 9 wherein said transaction is made between one party and at least one of a another party, a point of sale in a merchant facility, automated teller machine, business entity, governmental entity, non government organization, a not for profit organization, online, and a bank and wherein said party is at least one of a at least one individual(s) and at least one entity(s).

14. The system in accordance with claim 9 wherein said electronic payment utilizing said electronic device(s) includes at least one of a cash, at least one disposable electronic check(s), at least one disposable electronic money order(s), and at least one Transaction-in-Wait temporary holding account(s) bearing currency.

15. The system in accordance with claim 13 wherein processing payment to a recipient at a point of sale includes at least one of a central processing center, a recognized card swiped that is recognized by said processing center, at least one alphanumeric character(s) identifying an account holder to said processing center, at least one barcode(s), at least one pixel arrangement(s), at least one device(s) for reading said at least one of a said barcode and said pixel arrangement, and at least one camera attached to an electronic device wherein at least one of a said at least one alphanumeric character(s), at least one said barcode(s) and at least one said pixel arrangement(s) identify at least one of a merchant facility, specific cash register, a specific cashier, amount of transaction, the central processing center, and account holder identification for a specific amount to be paid in said transaction to at least one of a said recipient and said account holder.

16. The system in accordance with claim 9 wherein said monetary transaction utilizes at least one of a at least one alphanumeric character(s), a camera attached to an electronic communication device, at least one barcode(s), at least one pixel arrangement(s), and a card swiped, for transmitting said transaction information to at least one of a central processing center, the account holder, at least one another account holder(s), an entity, at least one electronic device(s).

17. The system in accordance with claim 9 wherein the central processing center issues to at least one of a at least one account holder(s), at least one entity(s), and at least one another party(s) in said transaction at least one of a unique personal account identification, unique personal password identification, and a unique personal identification of said processing center identifying uniquely said processing center to each recipient of said at least one of a unique account identification, and unique password identification.

18. The system in accordance with claim 17 wherein said at least one of a personal identification, and password is in a form that is at least one of a alphanumeric character, at least one of a tone, sound, voice signature, at least one fingerprint image, at least one barcode, and at least one pixel arrangement.

19. The system in accordance with claim 9 wherein said at least one transaction(s) is at least one of a transaction planned in advance, is monitored before transacting for sufficient funds, construed based on information available in a dedicated database compiling at least one of a monetary, and activity data, is brought to the attention of the account holder for at least one of a activation, adding currency to said account, and a reminder for needing to take at least one action(s).

20. The system in accordance with claim 9 wherein at least one payment(s) by buyer of goods for the benefit of seller of said goods is secured with a central processing center prior to shipping of said goods by said seller to said buyer wherein said payment(s) of said buyer for the benefit of said seller is released by said processing center to said seller upon said seller verifiable shipment of said goods to said buyer in accordance with a written agreement signed by both said seller and said buyer and deposited with said central processing center prior to said buyer depositing said payment(s) at said processing center.
